(19) United States
(12) Patent Application Publication
(10) Pub. No.: US 2013/0346737 A1
(43) Pub. Date: Dec. 26, 2013

(54) METHOD FOR REMOTELY POWERING ON HOST AND SYSTEM AND ELECTRONIC APPARATUS USING THE METHOD

(71) Applicants: Hsin-Chung Yu, Taipei City (TW); Chong-Kim Chan, Taipei City (TW); Yu-Guang Chen, Taipei City (TW)

(72) Inventors: Hsin-Chung Yu, Taipei City (TW); Chong-Kim Chan, Taipei City (TW); Yu-Guang Chen, Taipei City (TW)

(73) Assignee: ASROCK INC., Taipei City (TW)

(21) Appl. No.: 13/868,906

(22) Filed: Apr. 23, 2013

(30) Foreign Application Priority Data
Jun. 25, 2012 (TW) 101122644

(51) Int. Cl. G06F 9/44

(52) U.S. Cl. CPC G06F 9/4416
USPC 713/2

(57) ABSTRACT

A method for remotely powering on a host, a system using the method, and an electronic apparatus using the method are provided. In the method, a control apparatus is employed to connect a server and detect whether the server receives a booting command from a remote apparatus. When it is detected that the server receives the booting command, an activation signal is transmitted to the host by the control apparatus, so as to power on the host.

### CROSS-REFERENCE TO RELATED APPLICATION

This application claims the priority benefit of Taiwan application serial no. 101122644, filed on Jun. 25, 2012. The entirety of the above-mentioned patent application is hereby incorporated by reference herein and made a part of this specification.

### BACKGROUND

1. Technology Field

The disclosure relates to a remote control mechanism. More particularly, the disclosure relates to a method for remotely powering on a host, a system using the method, and an electronic apparatus using the method.

2. Description of Related Art

With the development of electronic technologies, computers and various information digitized equipment become increasingly prevalent, and the network has been playing an essential role in information exchange for sharing the resources. Since the network communication advances vigorously, most computer products may perform the function of network communication and also support a wake-on-LAN (WOL) function.

WOL is a technology and also refers to a standard that regulates said technology. With the WOL support, a computer in a sleep, hibernation, or shut-down mode is allowed to be resumed, woken up, or re-powered on by a remote network message.

Normally, under the WOL mechanism, the computer may be directly woken up through network connection. Nevertheless, the configuration of firewalls out of security concerns about data privacy usually prevents a remote user from accessing local area network of the computer through the internet. Alternatively, a remote computer may be powered on by accessing its internet protocol (IP) address via WOL. However, given that the computer is powered off and then powered on, the IP address of the computer then becomes dynamic, and therefore it is no longer possible to power the remote computer by accessing its IP address.

### SUMMARY

The disclosure is directed to a method for remotely powering on a host and a system using the method, such that the host in any mode may be powered on by a remote apparatus.

The disclosure is further directed to an electronic apparatus of which a control apparatus may remotely power on a host.

In an embodiment of the disclosure, a method for remotely powering on a host is provided. The method is suitable for a server and a remote apparatus on an internet. In the method, several steps are performed by a control apparatus. Here, the control apparatus is connected to the server through the internet and coupled to a host. Said steps include connecting the server and detecting whether the server receives a booting command from the remote apparatus. Besides, when the server is detected to have received the booting command, an activation signal is transmitted to the host to power on the host.

According to an embodiment of the disclosure, the step of connecting the server includes connecting the server according to an identification account number.

According to an embodiment of the disclosure, the server is an electronic mail server, and after the step of connecting the server is implemented, the method further includes a step of reading an electronic mail to determine whether the electronic mail has the booting command.

According to an embodiment of the disclosure, after the step of connecting the server is performed, the method further includes a step of transmitting an inquiry command to the server at certain time intervals, so as to detect whether the server receives the booting command.

According to an embodiment of the disclosure, the step of detecting whether the server receives the booting command further includes transmitting an inquiry command to the server, such that the server checks on a register. A reply is received from the server, so as to detect whether the server receives the booting command. Here, the reply includes a value of the register. When the value of the register is a first default value, it is determined that the server receives the booting command; when the value of the register is a second default value, it is determined that the server does not receive the booting command.

According to an embodiment of the disclosure, the step of transmitting the activation signal to the host includes transmitting the activation signal to the host through a connection interface, and the control apparatus is communicated with the server through a network interface.

In an embodiment of the disclosure, a remote power on system that includes a host, a remote apparatus, a server, and a control apparatus is provided. The remote apparatus transmits a booting command. The server is coupled to the remote apparatus and receives the booting command. The control apparatus is coupled to the host and the server. When the control apparatus is connected to the server, the control apparatus detects whether the server receives the booting command, and the control apparatus transmits an activation signal to the host after detecting that the server receives the booting command, so as to power on the host.

According to an embodiment of the disclosure, the control apparatus is connected to the server according to an identification account number.

According to an embodiment of the disclosure, the server is an electronic mail server, and the control apparatus detects whether the server receives the booting command by reading an electronic mail.

According to an embodiment of the disclosure, the control apparatus includes a calculating unit, a network interface, and a timing control unit. The network interface is coupled to the calculating unit, and the control apparatus communicates with the server through the network interface. The timing control unit is coupled to the calculating unit, and the timing control unit informs the calculating unit of transmitting an inquiry command to the server at certain time intervals, so as to detect whether the server receives the booting command.

According to an embodiment of the disclosure, the control apparatus transmits an inquiry command to the server through the internet, such that the server reads a value of a register and transmits a reply to the control apparatus through the internet. When the value of the register is a first default value, the control apparatus determines that the server receives the booting command; when the value of the register is a second default value, the control apparatus determines that the server does not receive the booting command.

According to an embodiment of the disclosure, the remote apparatus transmits an electronic mail to the server through the internet, and the electronic mail has the booting command.

According to an embodiment of the disclosure, the control apparatus transmits the activation signal to the host through a connection interface, and the control apparatus communicates with the server through the network interface.

In an embodiment of the disclosure, an electronic device that includes a host and a control apparatus is provided. The control apparatus is coupled to the host and connected to a server through an internet. When the control apparatus is connected to the server, the control apparatus detects whether the server receives a booting command, and the control apparatus transmits an activation signal to the host after detecting that the server receives the booting command, so as to power on the host.

In light of the foregoing, the booting command transmitted by the remote apparatus is received by the server. Besides, the control apparatus detects whether the server receives the booting command and acts as a relay station that issues the booting command to the host. When the control apparatus detects that the server receives the booting command, the control apparatus transmits an activation signal to the host to wake up the host. Thereby, the host may be powered on remotely at any time and any place in a diversified manner.

In order to make the aforementioned and other features and advantages of the disclosure more comprehensible, embodiments accompanying figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a block diagram illustrating a remote power on system according to an embodiment of the disclosure.

FIG. 1B is a block diagram illustrating a remote power on system according to another embodiment of the disclosure.

FIG. 2 is a flowchart illustrating a method for remotely powering on a host according to an embodiment of the disclosure.

### DESCRIPTION OF EMBODIMENTS

Generally, the WOL mechanism may be disabled under certain circumstances, such that a remote user is unable to boot a host. Specifically, when the host is in a shut-down mode or in a sleep mode, the WOL mechanism may be disabled if the firewall does not permit the remote user to power on the host through the internet or if the host has a dynamic IP address and is powered off and then powered on again. To resolve said issue, a method for remotely powering on a host and a remote power on system are provided herein, such that the host in any mode with power supply may be powered on by a remote apparatus. In order to make the disclosure more comprehensible, embodiments are described below as the examples to prove that the disclosure can actually be realized.

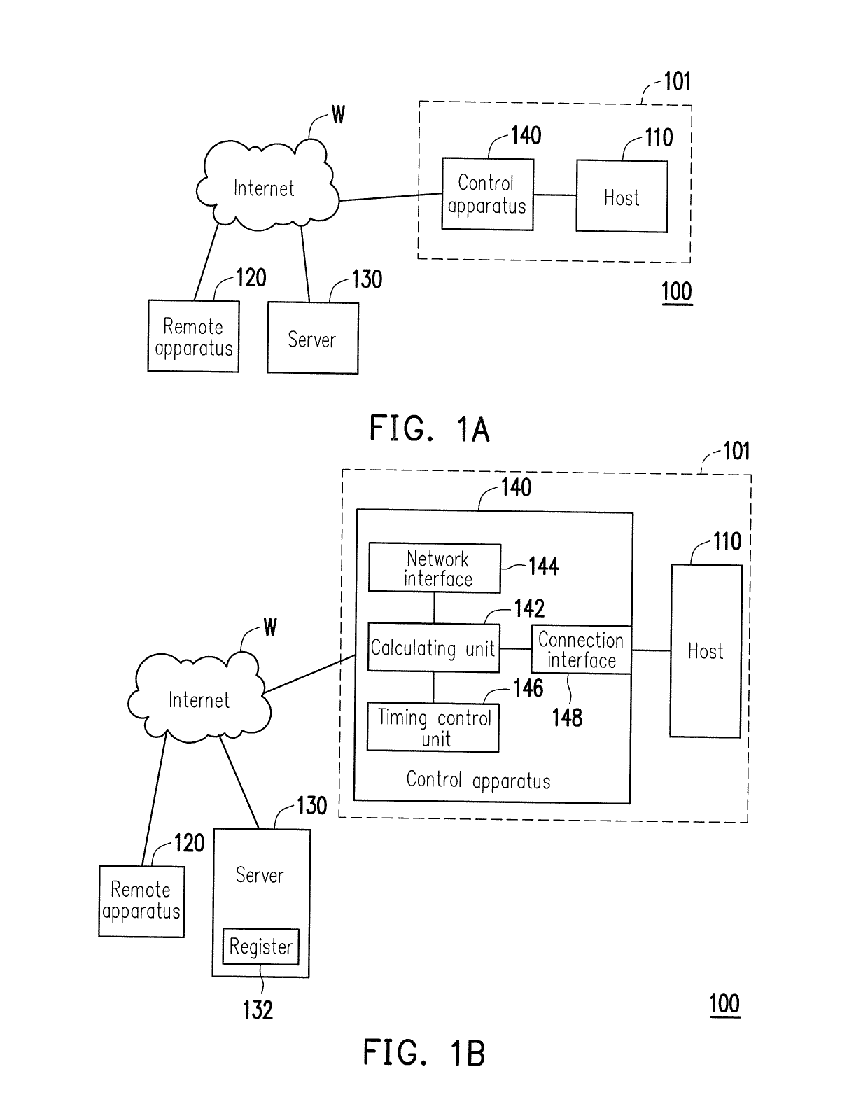

FIG. 1A is a block diagram illustrating a remote power on system according to an embodiment of the disclosure. With reference to FIG. 1A, the remote power on system 100 includes a host 110, a remote apparatus 120, a server 130, and a control apparatus 140. The server 130 is coupled to the remote apparatus 120. Here, the control apparatus 140 is respectively coupled to the host 110 and the server 120 and acts as a relay station for remotely powering on the host 110. That is, the control apparatus 140 is configured to monitor through the server 130 whether an authenticated remote apparatus 120 intends to power on the host 110. As long as the control apparatus 140 confirms the issuance of the booting command by the remote apparatus 120, the control apparatus 140 transmits an activation signal to the host 110.

In the remote power on system 100, the host 110 and the control apparatus 140 are configured in an electronic apparatus 101. Namely, the electronic apparatus 101 utilizes the control apparatus 140 to actively inquire the server 130 and detect whether the server 130 receives the booting command. If it is determined that the server 130 receives the booting command, the control apparatus 140 sends the activation signal to the host 110, so as to wake up the host 110. Here, the control apparatus 140 may be a chip embedded into a motherboard of the host 110 or may be externally connected to the host 110. Once power is supplied to the electronic apparatus 101, the control apparatus 140 constantly stays in an operational state.

In the present embodiment, the remote apparatus 120 transmits the booting command to the server 130 through the interne W, for instance. Here, the server 130 is a network server, for instance, and the server 130 may be connected to the remote apparatus 120 through the interne W and may receive the booting command transmitted by the remote apparatus 120. Besides, the server 130 may communicate with the control apparatus 140 through the internet W.

The host 110 and the remote apparatus 120 exemplarily include but are not limited to personal computers, notebook computers, personal digital assistants (PDA), mobile phones, or any other electronic apparatuses with the mobile communication function. For illustrative purposes, only one host 110 is depicted in the drawings, while the number of the host 110 should not be construed as a limitation to actual implementation of the disclosure. That is, through the remote power on system 100 described in the present embodiment, the remote apparatus 120 may select one of the hosts, and thereby the selected host in any mode (e.g., in a shut-down mode or a sleep mode) with power supply may be powered on remotely.

Components in the remote power on system 100 are elaborated in the following embodiment; nevertheless, the disclosure should not be construed as limited to the embodiment set forth herein.

FIG. 1B is a block diagram illustrating a remote power on system according to another embodiment of the disclosure. With reference to FIG. 1B, the server 130 may include a register 132. When a value of the register 132 is a first default value, it is determined that the server 130 receives the booting command from the remote apparatus 120. By contrast, when the value of the register 132 is a second default value, it is determined that the server 130 does not receive the booting command from the remote apparatus 120. The predetermined value of the register 132 may be set as the second default value; after the server 130 receives the booting command from the remote apparatus 120, the value of the register 132 may be changed to the first default value. In addition, when the control apparatus 140 controls a number of hosts 110, the number of registers 132 may be determined according to the number of hosts 110, i.e., one host 110 corresponds to one register 132.

Here, the register 132 is a flag, the first default value is 1, and the second default value is 0, for instance. The value of the register 132 may be pre-set as “0” (i.e., the second default value). After the server 130 receives the booting command for powering on the host 110 from the remote apparatus 120, the server 130 changes the value of the register 132 to “1” (i.e., the first default value). If, however, the server 130 does not receive the booting command for powering on the host 110 from the remote apparatus 120, the value of the register 132 constantly stays at “0”.

It should be mentioned that the server 130 may be an electronic mail server, and the remote apparatus 120 may transmit the booting command to the server 130 through an electronic mail. For instance, the electronic mail transmitted by the remote apparatus 120 may include text messages, numbers, or parameters as the booting command. Hence, after receiving the electronic mail, the server 130 may determine whether the electronic mail has the booting command according to the text messages, numbers, or parameters included in the electronic mail.

Additionally, the server 130 may be a server of a social network website, and the booting command may be issued by performing a messaging function supported by the social network website. The server 130 may also be a server of a communication application program in a smart phone.

The control apparatus 140 may include a calculating unit 142, a network interface 144, and a timing control unit 146. The network interface 144 is coupled to the calculating unit 142, and the timing control unit 146 is coupled to the calculating unit 142 as well. Here, the network interface 144 is a physical network port (e.g., Ethernet port), for instance. The control apparatus 140 may be communicated with the server 140 through the network interface 144.

The calculating unit 142 may transmit an inquiry command to the server 130 to inquire whether the server 130 receives the booting command. The timing control unit 140 provides a timing control mechanism. For instance, at certain time intervals, the timing control unit 146 may inform the calculating unit 142 of transmitting the inquiry command to the server 130. Thereby, the calculating unit 142 may determine that the server 130 receives the booting command according to the inquiry command. In other words, the combination of the calculating unit 142, the network interface 144, and the timing control unit 146 allows the control apparatus 140 to transmit the inquiry command to the server 130 at certain time intervals, so as to detect whether the server 130 receives the booting command.

In the present embodiment, the control apparatus 140 may be coupled to the host 110 through a connection interface 142, and thereby the control apparatus 140 may transmit the activation signal to the host 110. Here, the connection interface 142 is a peripheral component interconnect (PCI) interface, a peripheral component interconnect express (PCIE) interface, or a universal serial bus (USB) interface, for instance.

According to another embodiment of the disclosure, the control apparatus 140 may transmit the activation signal and power on the host 110 by means of a network component (e.g., a network card) which is configured on the motherboard and supports the WOL function. Said network component may refer to the network card which is also employed for connecting the server 130 or another network card.

The control apparatus 140 at certain time intervals detects whether the server 130 receives the booting command; therefore, given that the host 110 is in a shut-down mode or in a sleep mode, and that the control apparatus 140 detects that the server 130 receives the booting command, the control apparatus 140 may transmit the activation signal to the host 110 through the connection interface 148, so as to power on the host 110.

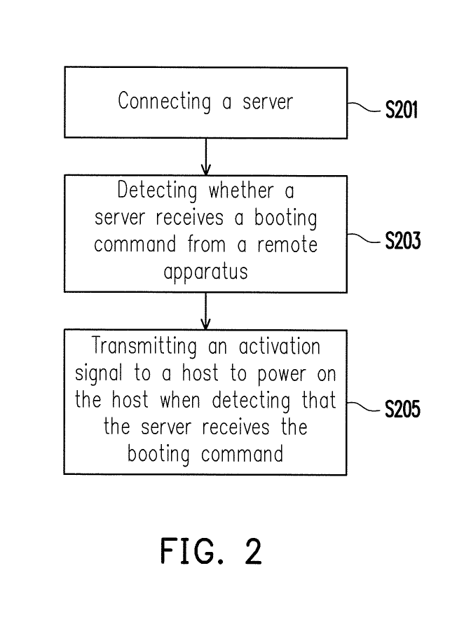

A method for remotely powering on a host is described hereinafter with reference to the above-mentioned remote power on system 100. FIG. 2 is a flowchart illustrating a method for remotely powering on a host according to an embodiment of the disclosure. The method described in the present embodiment is suitable for powering on the host 110 through the control apparatus 140. Here, the host 110 is in the shut-down mode or in the sleep mode, for instance.

With reference to FIG. 1A, FIG. 1B, and FIG. 2, in step S201, the control apparatus 140 connects the server 130. The control apparatus 140 may be communicated with the server 130 through the interne W, for instance.

In step S203, the control apparatus 140 detects whether the server 130 has a booting command. For instance, the control apparatus 140 may, through the timing control unit 146, inform the calculating unit 142 of transmitting an inquiry command to the server 130 at certain time intervals, so as to detect whether the server 130 receives the booting command. Each of said time intervals may be set as t minutes (a period of time), and every other t minutes the control apparatus 140 may transmit the inquiry command to the server 130, so as to detect whether the server 130 receives the booting command.

To be more specific, the timing control unit 146 may inform the calculating unit 142 every other t minutes; thereby, the calculating unit 142 may transmit the inquiry command to the server 130, and the server 130 may then check on the value of the register 132. After the server 130 retrieves the value of the register 132, the server 130 may transmit a reply to the control apparatus 140. In case of a number of hosts 110, the server 130 may one by one check on the value of the register 132 corresponding to each individual host 110 according to another embodiment of the disclosure.

After the control apparatus 140 receives the reply from the server 130, the calculating unit 142 may determine whether the server 130 receives the booting command according to the reply. For instance, the received reply includes the value of the register 132. When the value of the register 132 is a first default value, the calculating unit 142 determines that the server 130 receives the booting command; when the value of the register 132 is a second default value, the calculating unit 142 determines that the server 130 does not receive the booting command.

For instance, the host 110 is assumed to have an identification code “01” and correspond to the register 132. At the same time, the pre-set value of the register 132 is assumed to be “0” (i.e., the second default value).

After the remote apparatus 120 transmits the command for powering on the host 110 with the identification code “01” to the server 130, the server 130 changes the value of the register 132 (corresponding to the host 110 with the identification code “01”) to “1” (i.e., the first default value). If, however, the server 130 does not receive the booting command for powering on the host 110 from the remote apparatus 120, the value of the register 132 constantly stays at “0”. Thereby, the control apparatus 140 is able to detect whether the server 130 receives the command for powering on the host 110 from the remote apparatus 120.

In addition, if the server 130 is an electronic mail server and receives an electronic mail from the remote apparatus 120, the server 130 may self-determine whether the electronic mail has the command for powering on the host 110; if yes, the value of the register 132 corresponding to the host 110 is set to be the first default value. The control apparatus 140 may then be connected to the server 130 according to an identification account number. Here, the identification account number includes an electronic mail account number and a password. Similarly, the control apparatus 140 may transmit the inquiry command to the server 130 at certain time intervals, so as to detect whether the server 130 receives the booting command.

In step S205, when the control apparatus 140 detects that the server 130 receives the booting command, the control apparatus 140 transmits an activation signal to the host 110 to wake up the host 110. Particularly, the control apparatus 140 may transmit the activation signal to the host 110 through the connection interface 148. Namely, when the host 110 is in the shut-down mode or in the sleep mode, the control apparatus 140 is able to power on the host 110 even though the host 110 may have a dynamic IP address.

To sum up, as described in the previous embodiments, the booting command transmitted by the remote apparatus is received by the server, and the control apparatus actively detects whether the server receives the booting command for powering on the host. Once the server is detected to have received the booting command, the control apparatus transmits the activation signal to the host, so as to power on the host (e.g., power on the host or wake up the host). Due to the configuration of the control apparatus and the server, the remote apparatus may transmit the booting command for powering on the host to the server, and then the control apparatus may transmit the activation signal to the host to power on the host. As such, a user is able to remotely control the host through the remote apparatus at any time and any place.

Although the disclosure has been described with reference to the above embodiments, it will be apparent to one of the ordinary skill in the art that modifications to the described embodiment may be made without departing from the spirit of the disclosure. Accordingly, the scope of the disclosure will be defined by the attached claims not by the above detailed descriptions.

What is claimed is:

1. A method for remotely power on a host, the method being suitable for a server and a remote apparatus on an internet and comprising:
performing steps by a control apparatus, the control apparatus being connected to the server through the internet and coupled to the host, the steps comprising:
connecting the server;
detecting whether the server receives a booting command from the remote apparatus through the internet; and
when the server is detected to have received the booting command, transmitting an activation signal to the host to power on the host.

2. The method as recited in claim 1, wherein the step of connecting the server comprises:
connecting the server according to an identification account number.

3. The method as recited in claim 1, wherein the server is an electronic mail server, and after the step of connecting the server is performed, the method further comprises:
reading an electronic mail to determine whether the electronic mail has the booting command.

4. The method as recited in claim 1, wherein after the step of connecting the server is performed, the method further comprises:
transmitting an inquiry command to the server at time intervals, so as to detect whether the server receives the booting command.

5. The method as recited in claim 1, wherein the step of detecting whether the server receives the booting command comprises:
transmitting an inquiry command to the server, such that the server checks on a register;
receiving a reply from the server, so as to detect whether the server receives the booting command, wherein the reply comprises a value of the register,
when the value of the register is a first default value, determining that the server receives the booting command, and
when the value of the register is a second default value, determining that the server does not receive the booting command.

6. The method as recited in claim 1, wherein the control apparatus is communicated with the server through a network interface, and the control apparatus transmits the activation signal to the host through a connection interface.

7. A remote power on system suitable for an internet, the remote power on system comprising:
a host;
a remote apparatus on the internet, the remote apparatus transmitting a booting command;
a server on the internet, the server receiving the booting command through the internet; and
a control apparatus coupled to the host, wherein when the control apparatus is connected to the server, the control apparatus detects whether the server receives the booting command, and the control apparatus transmits an activation signal to the host after detecting that the server receives the booting command, so as to power on the host.

8. The remote power on system as recited in claim 7, wherein the control apparatus is connected to the server according to an identification account number.

9. The remote power on system as recited in claim 8, wherein the server is an electronic mail server, and the control apparatus detects whether the server receives the booting command by reading an electronic mail.

10. The remote power on system as recited in claim 7, wherein the control apparatus comprises:
a calculating unit;
a network interface coupled to the calculating unit, the control apparatus communicating with the server through the network interface; and
a timing control unit coupled to the calculating unit, wherein the timing control unit informs the calculating unit of transmitting an inquiry command to the server at time intervals, so as to detect whether the server receives the booting command.

11. The remote power on system as recited in claim 7, wherein the control apparatus transmits an inquiry command to the server through the internet, such that the server reads a value of a register and transmits a reply to the control apparatus through the internet,
wherein when the value of the register is a first default value, the control apparatus determines that the server receives the booting command, and when the value of the register is a second default value, the control apparatus determines that the server does not receive the booting command.

12. The remote power on system as recited in claim 7, wherein the remote apparatus transmits an electronic mail to the server through the internet, and the electronic mail has the booting command.

13. The remote power on system as recited in claim 7, wherein the control apparatus transmits the activation signal to the host through a connection interface, and the control apparatus communicates with the server through the network interface.

14. An electronic apparatus comprising:
a host; and
a control apparatus coupled to the host and connected to a server through an interne, wherein when the control apparatus connects the server, the control apparatus detects whether the server receives a booting command, and the control apparatus transmits an activation signal to the host after detecting that the server receives the booting command, so as to power on the host.

15. The electronic apparatus as recited in claim 14, wherein the server is an electronic mail server and receives an electronic mail through the internet, the electronic mail is transmitted by a remote apparatus and has the booting command, and
the control apparatus connects the server through the interne according to an identification account number, so as to detect whether the electronic mail has the booting command.

16. The electronic apparatus as recited in claim 14, wherein the control apparatus comprises:
a calculating unit;
a network interface coupled to the calculating unit, the control apparatus communicating with the server through the network interface; and
a timing control unit coupled to the calculating unit, wherein the timing control unit informs the calculating unit of transmitting an inquiry command to the server at time intervals, so as to detect whether the server receives the booting command.
